(19) United States
(12) Patent Application Publication
(10) Pub. No.: US 2002/0029008 A1
(43) Pub. Date: Mar. 7, 2002

(54) Humbird

(76) Inventors: Alberto Pow Wong, N. Laredo (MX); Hector Calderon Perez, N. Laredo (MX)

Correspondence Address: Alberto Pow Wong, 1605 Benavides, Laredo, TX, 78040, US

(21) Appl. No.: 09/853,168

(22) Filed: May 11, 2001

Related U.S. Application Data
(60) Provisional application No. 09/885,258.

(51) Int. Cl. A61H 1/00

(52) U.S. Cl. 601/46

(57) ABSTRACT

We Alberto Pow Wong and Hector Calderon Perez, inventors of the machine titled “HUMBIRD” like to point out that this machine is a sexual helper for women whom used to have good orgasms and now are having difficulty to have them; so, thinking on the woman, we developed this machine, because it is a fact that science and technology is to be applied everywhere, and knowing that most sexual devices have the shape of the male organ, have large straps, or boxes to hold thye batterys, with long pieces of wire that get messed up most times. “HUMBIRD” does not have outside wires, is safe to use, and does not have straps but a single belt, to hold the machine over the pennis.

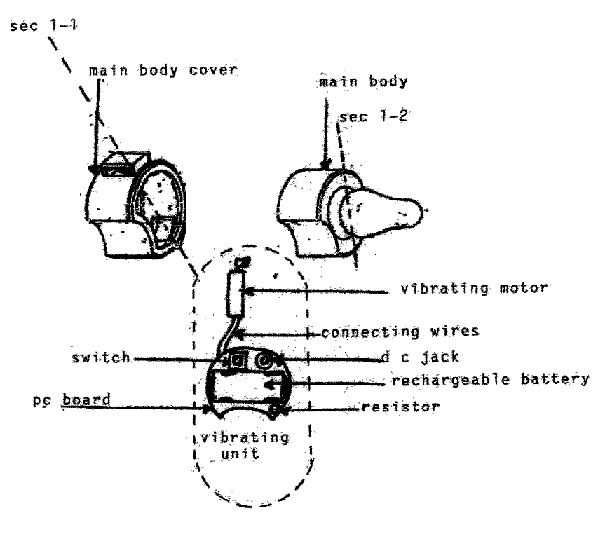

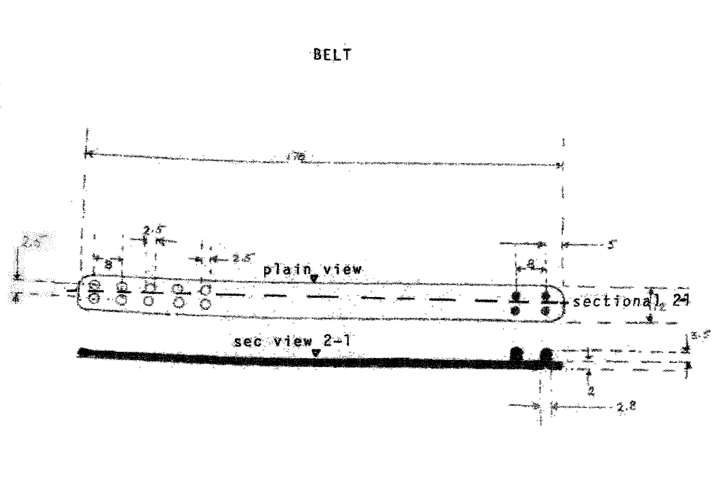

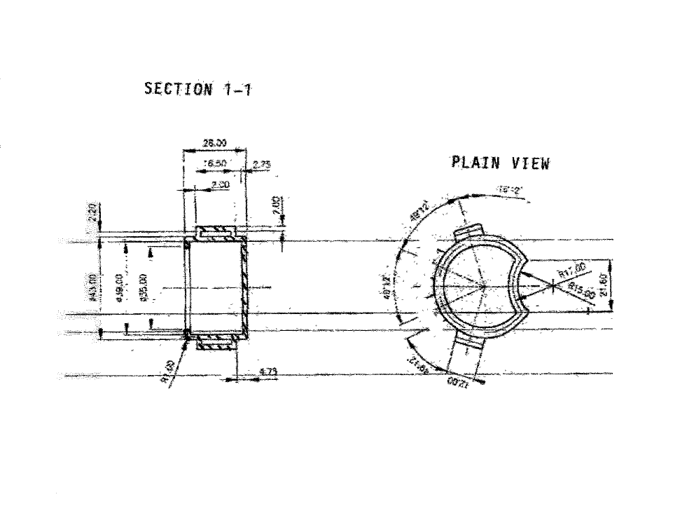

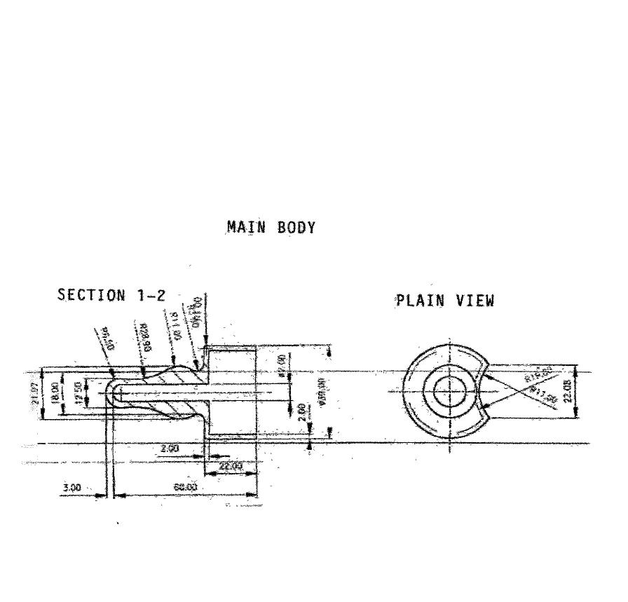

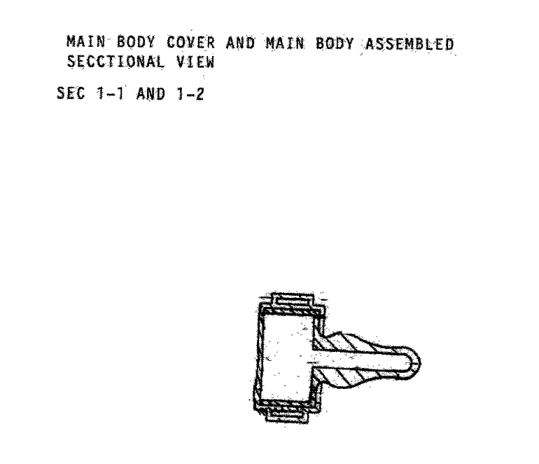

### REFERENCE TO A MICROFICHE APPENDIX

“Not applicable”

### BACKGROUND OF THE INVENTION

Our invention, titled “HUMBIRD” is to be used as a sexual aid for women whom have lost the ability to reach orgasms during intercourse, same way as our prior invention titled “Coitus Stimulator” which has an application Ser. No. 60/205,479 and a filing date May 19, 2000 for a Provisional Application and is actually under petition to be converted to a Non Provisional Application. As for “HUMBIRD” we have made a different design, concerning shape. This will help to have a closer contact to the clitorial area of the women.

Another change that was made, is that “HUMBIRD” has been provided with a rechargeable battery, and a charger. This gives a use-time of two hours, while “Coitus Stimulator” works only 30 minutes and then the battery has to be replaced.

Also, the belt that holds the “HUMBIRD” to the male sexual organ, has been designed in a different way as the previous “Coitus Stimulator” and now is a separated from the main body. If this belt Gets broken, it can be replaced with no difficulty at all.

### BRIEF SUMMARY OF THE INVENTION

The invention titled “HIUMBIRD” is vibrating device, wireless to be used in the intercourse. It is to be atached to the penis by means of a rubber band. When the couple mates, it provides a very close contact with the clitorial area of the woman, and a mechanical vibration which stimulates in a pleasant way, leading the woman to an orgasm.

One important thing about this invention is that it is wireless and and does not have to be inserted in any orifice.

This new invention helps to solve the main problem which was the lasting power which was 30 minutes on the previous titled “Coitus Stimulator”

The new Invention “HUMBIRD” lasts two hours with a fully recharged battery. We use the term “fully recharged” because it has a niquel-cadmium rechargeable battery and can be recharged over and over, according to the life of the battery.

We state that the object of this invention is to help women, mainly married women, to reach orgasms during intercourse, with their husband or partner.

### BRIEF DESCRIPTION OF THE DRAWINGS

Page 1.—is a drawing of the main components of the invention titled “HUMBIRD” and consist of a main body, cover main body, and vibrating unit.

Page 2.—covers another of the main components, the belt, and a section view of it.

Page 3.—Covers section view and plain view of the mainbody cover

Page 4.—Covers section view and plain view of Main body

Page 5.—Covers section view of main body and cover body assembled together.

### DETAILED DESCRIPTION OF THE INVENTION

Our invention, titled “HUMBIRD” is a device made out of soft silicon rubber, has a cavity, in which we inserted a small printed circuit board with a rechargeable N type battery, a switch and a jack for recharging the battery. we also inserted a tinny vibrating motor (see drawings, page 1)

We also provided an adjustable elastic belt (drawings page 2) which is to hold the “HUMBIRD” over the base of the shaft of the penis. It has been possible to make these articles by means of expensive tooling, and a process of silicon injection.

### HOW TO USE IT

The device has to be charged for at least 5 hours. Once you have full charge, put the “HUMBIRD” on the base of the penis and switch to the on position, prior to the insertion of the penis into the vagina. Remember that the end of the device must touch the clitorial area of the woman, while copulating.

One important fact about diference from the old sexual devices is that “HUMBIRD” has no wires, no boxes of batteries, no straps, other than the elastic belt, is pretty small and does not have to be inserted in any female cavity, and, does not have the shape of the male organ.

1. We, Alberto Pow Wong and Hector Calderon Perez, claim that our invention titled “HUMBIRD” has been built already and has been tested among married couples in the country of Mexico and its performance is excellent.

2. We, claim that we need to be granted with a patent number in the United States, because, in a future, we are going to make and commercialize “HUMBIRD” in the USA:

3 We claim that our invention titled “HUMBIRD” is a big help to married couples whom could be get into a divorce situation because of lack of good sexual life in common.
